(19) United States
(12) Patent Application Publication
(10) Pub. No.: US 2024/0002005 A1
(43) Pub. Date: Jan. 4, 2024

(54) STRADDLED VEHICLE

(71) Applicant: YAMAHA HATSUDOKI KABUSHIKI KAISHA, Iwata-shi (JP)

(72) Inventors: Daisuke UCHIYAMA, Shizuoka (JP); Katsuya HARUTA, Shizuoka (JP)

(21) Appl. No.: 18/088,329

(22) Filed: Dec. 23, 2022

(30) Foreign Application Priority Data
Jun. 30, 2022 (JP) 2022106374

(51) Int. Cl. B62J 23/00; B62J 11/16; B62J 17/00; B62J 50/26

(52) U.S. Cl. CPC B62J 23/00; B62J 11/16; B62J 17/00; B62J 50/26

(57) ABSTRACT

A straddled vehicle includes a front wheel, a front fork, a cover, a brake, a brake hose, and a protector. The front fork rotatably supports the front wheel. The cover is disposed in front of the front fork. The brake is attached to the front wheel. The brake hose is connected to the brake and extends upward behind the cover. The protector is attached to the brake hose. The brake hose includes a first hose, a second hose, and a shrink tube. The second hose is provided separately from the first hose. The shrink tube is disposed behind the cover and connects the first hose and the second hose. The protector is disposed behind the cover and covers the shrink tube.

### CROSS-REFERENCE TO RELATED APPLICATIONS

This application is based on, and claims priority from, Japanese Patent Application No. 2022-106374, filed on Jun. 30, 2022. The contents of the application is incorporated herein by reference.

### FIELD

The present invention relates to a straddled vehicle.

### BACKGROUND

Some straddled vehicles have a brake hose disposed to pass behind a cover disposed in front of a front fork. For example, a motorcycle disclosed in Japanese Patent Application Publication No. H7-257459 has a number plate portion disposed in front of the front fork. A brake hose extends upward from a front brake through behind the number plate portion.

### SUMMARY

Some straddled vehicles have a brake hose including a first hose and a second hose that are provided separately from each other. For example, the first hose is a flexible hose that freely deforms according to the expansion and contraction of the front fork. The second hose is a stiff hose and has high abrasion resistance. In such a brake hose, it is desired that the first hose and the second hose are connected to each other in a waterproof manner.

Also, the brake hose moves according to the expansion and contraction of the front fork. Therefore, when the brake hose is disposed so as to pass behind the cover, there is concern that the connecting portion between the first hose and the second hose may rub against the cover and be damaged. It is an object of the present invention to connect a first hose and a second hose of a brake hose to each other in a waterproof manner and to suppress breakage of a connecting portion of the brake hose in a straddled vehicle.

A straddled vehicle according to one aspect of the present invention includes a front wheel, a front fork, a cover, a brake, a brake hose, and a protector. The front fork rotatably supports the front wheel. The cover is disposed in front of the front fork. The brake is attached to the front wheel. The brake hose is connected to the brake and extends through behind the cover. The protector is attached to the brake hose. The brake hose includes a first hose, a second hose, and a shrink tube. The second hose is provided separately from the first hose. The shrink tube is disposed behind the cover and connects the first hose and the second hose. The protector is disposed behind the cover and covers the shrink tube.

In the straddled vehicle according to the present aspect, the shrink tube connects the first hose and the second hose to each other. The shrink tube is made of soft rubber, for example, and shrinks when heat is applied. Thereby, the first hose and the second hose of the brake hose are connected to each other in a waterproof manner. Also, the shrink tube is protected by the protector. As a result, when the brake hose moves due to expansion and contraction of the front fork, it is possible to prevent the shrink tube from rubbing against the cover and being damaged.

The protector may include a first divided body and a second divided body. The first divided body may cover the shrink tube from one side. The second divided body may cover the shrink tube from the other side and be attached to the first divided body. In this case, the protector is divided into the first divided body and the second divided body. Thereby, the protector can be easily attached to the brake hose so as to cover the shrink tube.

The straddled vehicle may further include a tie band. The tie band may fix the first divided body and the second divided body to each other. In this case, the tie band easily fixes the first divided body and the second divided body to each other.

The protector may include a concave groove. The concave groove may extend in the circumferential direction on the surfaces of the first divided body and the second divided body. The tie band may be placed in the concave groove. In this case, displacement of a position of the tie band is suppressed.

The protector may include a hole and a protrusion. The shrink tube may be disposed in the hole. The protrusion may be disposed on the inner surface of the hole and engage the shrink tube. In this case, displacement of a position of the protector is suppressed.

The second hose may be made of a harder material than the first hose. In this case, wear of the second hose is suppressed. Further, even if the first hose and the second hose have different hardnesses, the shrink tube connects the first hose and the second hose of the brake hose to each other in a waterproof manner.

The cover may include a guide that guides the second hose. In this case, the movement of the second hose due to the expansion and contraction of the front fork is suppressed by the guide. Also, when the brake hose moves, the protector prevents the shrink tube from rubbing against the guide.

The straddled vehicle may further include an upper bracket attached to the front fork. The cover may be attached to the upper bracket. The cover may be a number plate.

The protector may have a tapered shape. In this case, the protector is prevented from being caught on the cover.

### BRIEF DESCRIPTION OF THE DRAWINGS

FIG. 1 is a side view of a straddled vehicle according to an embodiment.

FIG. 2 is a front view of the straddled vehicle.

FIG. 3 is a side view showing a structure of a cover and its surroundings.

FIG. 4 is a front view showing the structure of the cover and its surroundings.

FIG. 5 is a rear view showing the structure of the cover and its surroundings.

FIG. 6 is a diagram showing a part of a protector and a brake hose.

FIG. 7 is a vertical cross-sectional view showing a part of the protector and the brake hose.

FIG. 8 is a side view of the protector.

FIG. 9 is a diagram showing a first divided body.

FIG. 10 is a diagram showing a second divided body.

### DESCRIPTION OF EMBODIMENTS

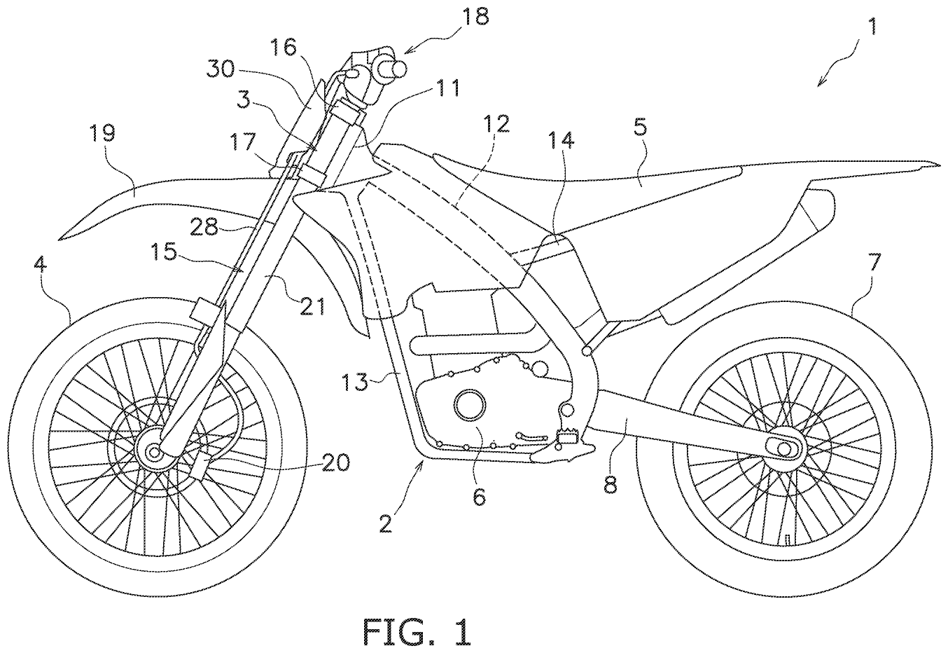

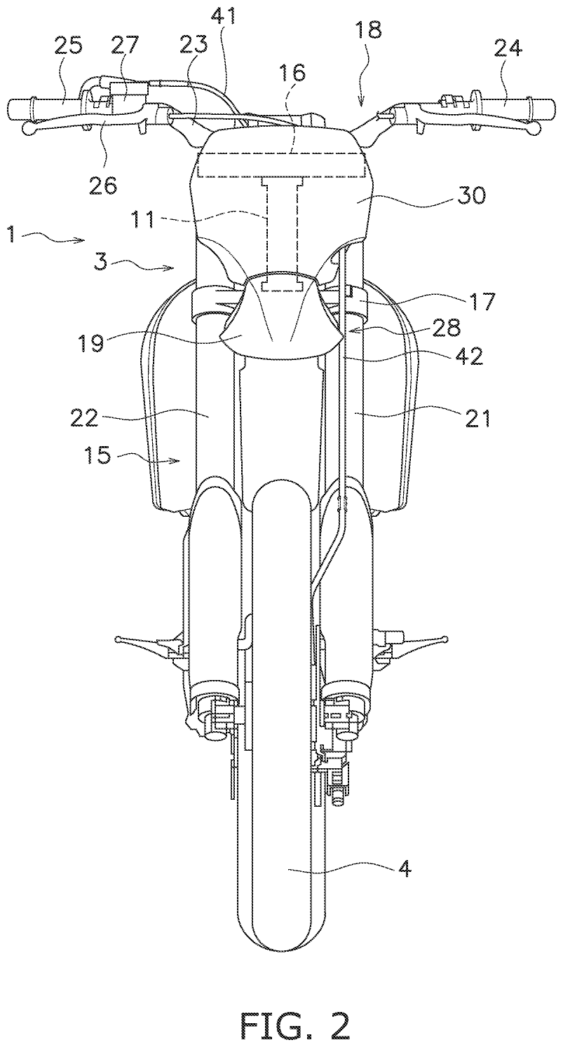

A straddled vehicle according to an embodiment will be described below with reference to the drawings. FIG. 1 is a side view of a straddled vehicle 1 according to an embodiment. FIG. 2 is a front view of the straddled vehicle 1. The straddled vehicle 1 is a so-called off-road type motorcycle. As shown in FIGS. 1 and 2, the straddled vehicle 1 includes a vehicle body frame 2, a steering device 3, a front wheel 4, a seat 5, a power unit 6, a rear wheel 7, and a swing arm 8. In this embodiment, the front, rear, left, and right directions refer to the front, rear, left, and right directions as seen from the rider seated on the seat 5.

The vehicle body frame 2 includes a head pipe 11, a first main frame 12, a second main frame 13, and a rear frame 14. The head pipe 11 extends forward and downward. The first main frame 12 is connected to the head pipe 11. The first main frame 12 extends from the head pipe 11 through behind the power unit 6. The first main frame 12 extends rearward and downward.

The second main frame 13 is connected to the head pipe 11. The second main frame 13 extends from the head pipe 11 through in front of the power unit 6. The rear frame 14 is connected to the first main frame 12. The rear frame 14 extends rearward and upward from the first main frame 12.

The steering device 3 is rotatably supported by the head pipe 11. The steering device 3 is configured to be steered by a rider. The steering device 3 includes a front fork an upper bracket 16, a lower bracket 17, and a handle member 18. The front fork 15 is rotatably supported by the head pipe 11. The front fork 15 includes a left suspension 21 and a right suspension 22. The front fork 15 rotatably supports the front wheel 4. A front brake 20 is attached to the front wheel 4. A front fender 19 is disposed above the front wheel 4.

The upper bracket 16 is connected to the left suspension 21 and the right suspension 22. The upper bracket 16 is disposed above the head pipe 11. The lower bracket 17 is disposed below the head pipe 11. The lower bracket 17 is connected to the left suspension 21 and the right suspension 22.

The handle member 18 is connected to the front fork 15. The handle member 18 is operable left and right by a rider. As shown in FIG. 2, the handle member 18 includes a handlebar 23, a left grip 24, and a right grip 25. The handlebar 23 is connected to the front fork 15 via the upper bracket 16. The left grip 24 is attached to the left end of the handlebar 23. The right grip 25 is attached to the right end of the handlebar 23.

A brake lever 26 and a master cylinder 27 are attached to the handle member 18. The brake lever 26 is disposed in front of the right grip 25. The master cylinder 27 is connected to the brake lever 26. The master cylinder 27 is disposed adjacent to the brake lever 26. A brake hose 28 connects the master cylinder 27 and the front brake 20. Hydraulic pressure for driving the front brake 20 is supplied from the master cylinder 27 to the front brake 20 via the brake hose 28 in response to the operation of the brake lever 26.

The seat 5 is disposed behind the head pipe 11. The seat 5 is supported by the vehicle body frame 2. The power unit 6 is disposed below the seat 5. The power unit 6 is supported by the first main frame 12 and the second main frame 13. The power unit 6 includes, for example, an internal combustion engine. Alternatively, the power unit 6 may include an electric motor.

The power unit 6 generates driving force for rotating the rear wheel 7. The rear wheel 7 is disposed behind the power unit 6. The rear wheel 7 is connected to the first main frame 12 via the swing arm 8. The swing arm 8 is swingably supported by the first main frame 12. The rear wheel 7 is rotatably supported by the swing arm 8.

The straddled vehicle 1 includes a cover 30. The cover 30 is a number plate. A number sticker used, for example, in an off-road motorcycle race is attached to the number plate. The cover 30 is made of resin, for example. However, the cover 30 may be made of metal such as aluminum. The cover 30 is disposed in front of the front fork 15. The cover 30 is attached to the upper bracket 16. The cover 30 rotates left and right together with the front fork 15. The cover 30 is disposed in front of the head pipe 11. As shown in FIG. 2, the cover 30 overlaps the head pipe 11 as seen in a vehicle front view. A lower end of the cover 30 is connected to the front fender 19.

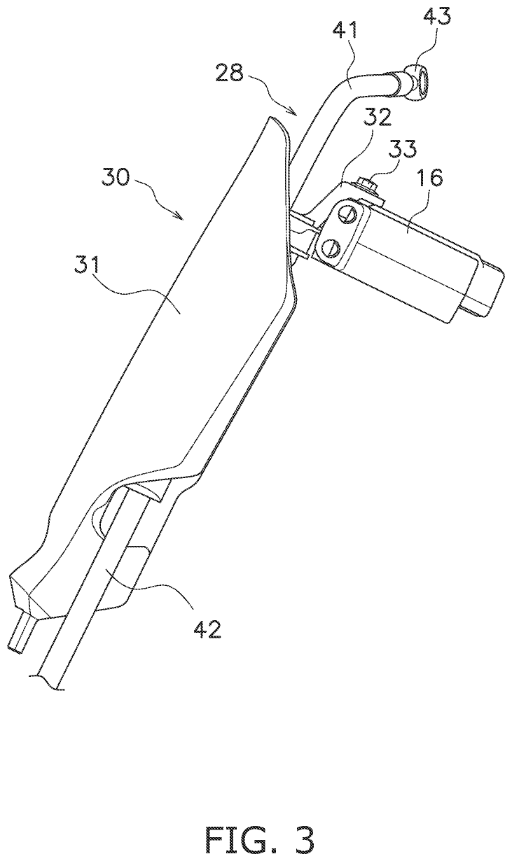

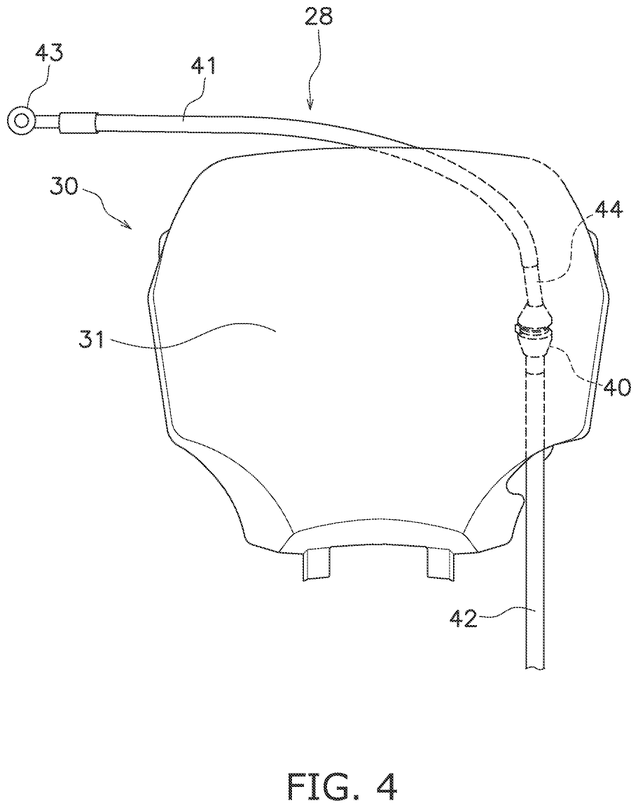

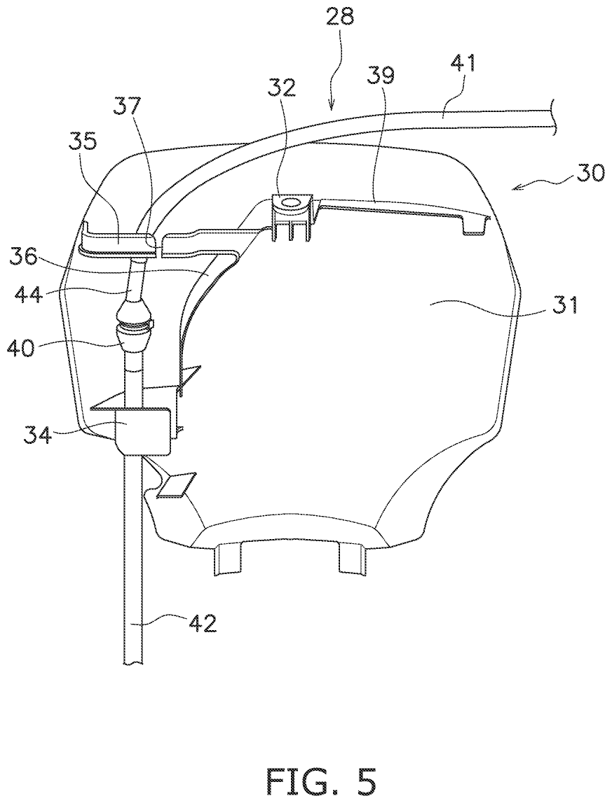

FIG. 3 is a side view showing a structure of the cover 30 and its surroundings. FIG. 4 is a front view showing the structure of the cover 30 and its surroundings. FIG. 5 is a rear view showing the structure of the cover 30 and its surroundings. As shown in FIGS. 3 to 5, the cover 30 includes a cover body 31 and a connecting portion 32. The cover body 31 has a curved plate-like shape. The number sticker is attached to the front surface of the cover body 31. The connecting portion 32 extends rearward from the back surface of the cover body 31. The connecting portion 32 is attached to the upper bracket 16. The connecting portion 32 is fixed to the upper bracket 16 with a bolt 33.

The brake hose 28 extends through the rear of the cover 30 as shown in FIGS. 3 to 5. As seen in the vehicle rear view, the brake hose 28 extends leftward from a position above and rightward of the cover 30 through above the connecting portion 32. As seen in the vehicle rear view, the brake hose 28 is curved downward and extends downward on the left side of the connecting portion 32. As shown in FIG. 4, a part of the brake hose 28 overlaps the cover 30 as seen in the vehicle front view.

As shown in FIG. 5, the cover 30 includes a first guide 34, a second guide 35, and a third guide 36 for guiding the brake hose 28. The first guide 34, the second guide and the third guide 36 are provided on the back surface of the cover body 31.

The first guide 34 has a U-shaped bent shape. The first guide 34 covers the front, rear, and outer lateral side of the brake hose 28. The inner lateral side of the first guide 34 is open. The second guide 35 is disposed above the first guide 34. The second guide 35 extends in the left-right direction. The second guide 35 covers the rear and outer lateral side of the brake hose 28. The width of the second guide 35 is larger than the width of the first guide 34 in the left-right direction. The second guide 35 includes a slit 37 extending vertically through the second guide 35. The width of slit 37 is smaller than the diameter of the brake hose 28.

The third guide 36 has a plate-like shape protruding rearward from the back surface of the cover body 31. The third guide 36 is disposed laterally inward of the brake hose 28. The third guide 36 is disposed between the connecting portion 32 and the first guide 34 in the left-right direction. The third guide 36 has a shape curved upward and rightward. The third guide 36 is connected to the second guide 35. The third guide 36 is connected to the connecting portion 32. The third guide 36 extends leftward and downward from the connecting portion 32. The cover 30 includes a rib 39. The rib 39 protrudes rearward from the back surface of the cover body 31. The rib 39 is disposed below the brake hose 28. The rib 39 extends in the left-right direction. The rib 39 is connected to the connecting portion 32. The rib 39 extends rightward from the connecting portion 32. The rib 39 improves the rigidity of cover 30.

The brake hose 28 bends according to the expansion and contraction of the front fork 15, thereby moving relative to the cover 30. The first to third guides 34 to 36 restrict movement of the brake hose 28. The first guide 34 restricts forward, rearward, and laterally outward movement of the brake hose 28. The second guide 35 restricts rearward and laterally outward movement of the brake hose 28. The third guide 36 restricts the laterally inward movement of the brake hose 28.

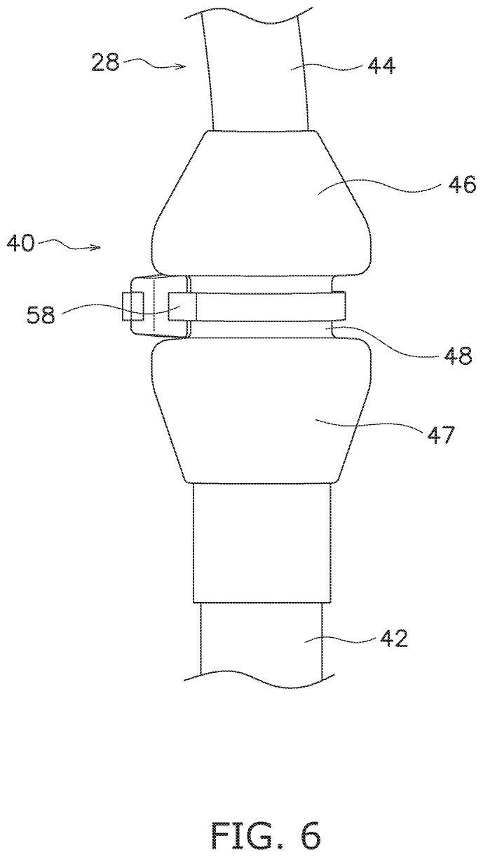

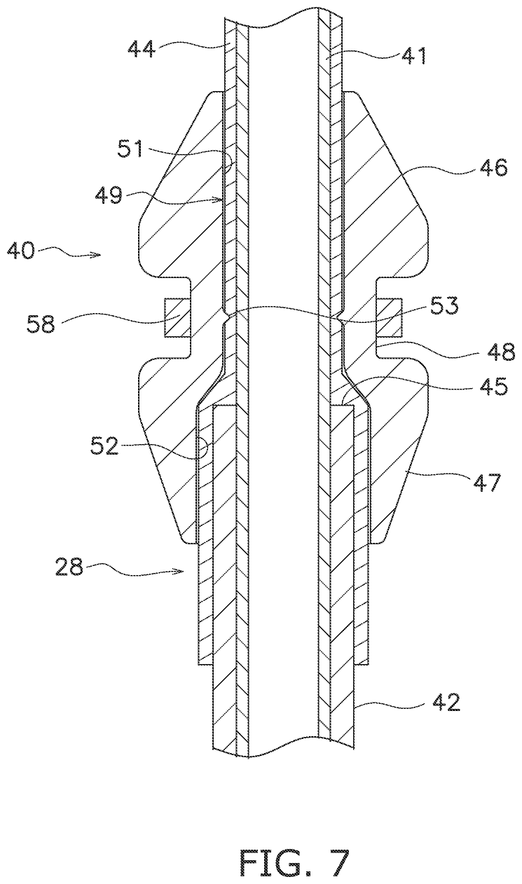

As shown in FIGS. 4 and 5, a protector 40 is attached to the brake hose 28. FIG. 6 is a diagram showing a part of the protector 40 and the brake hose 28. FIG. 7 is a vertical cross-sectional view showing a part of the protector 40 and the brake hose 28. As shown in FIG. 7, the brake hose 28 includes a first hose 41 and a second hose 42. The first hose 41 is a flexible hose. The first hose 41 is made of flexible resin. The first hose 41 is connected to the master cylinder 27 and the front brake 20.

As shown in FIGS. 3 and 4, a joint 43 is connected to one end of the first hose 41. The first hose 41 is connected to the master cylinder 27 via the joint 43. A joint (not shown) is connected to the other end of the first hose 41. The first hose 41 is connected to the front brake 20 via the joint. In addition, the first hose 41 may be integrated, or may include a plurality of hoses that are provided separately from each other and connected to each other.

The second hose 42 is provided separately from the first hose 41. The second hose 42 is attached to the first hose 41 so as to partially cover the first hose 41. The second hose 42 is made of resin that is harder than the first hose 41. The second hose 42 extends from behind the cover 30 to below the cover 30. As shown in FIG. 2, the second hose 42 extends downward along the left suspension 21 from behind the cover 30.

The first hose 41 is protected by the second hose 42. The first guide 34 described above guides the second hose 42. The first hose 41 is exposed to the outside above the second hose 42. The second guide 35 described above guides the first hose 41 above the second hose 42. The first hose 41 curves rightward above the second hose 42. A portion of the first hose 41 disposed above the second hose 42 is freely deformable according to the expansion and contraction of the front fork 15.

As shown in FIG. 7, the brake hose 28 includes a shrink tube 44. The shrink tube 44 connects the first hose 41 and the second hose 42. The shrink tube 44 shrinks by heat while being covered the end portion 45 of the second hose 42 and the first hose 41 to fix the second hose 42 to the first hose 41. The shrink tube 44 adheres to the end portion 45 of the second hose 42 and the first hose 41 to fix the end portion 45 of the second hose 42 and the first hose 41 to each other in a waterproof manner. The shrink tube 44 is made of rubber, for example. The shrink tube 44 is disposed behind the cover 30.

The protector 40 covers the shrink tube 44. The protector 40 is made of resin, for example. The protector 40 covers the shrink tube 44 at a position where the end portion 45 of second hose 42 overlaps the first hose 41. The protector 40 is disposed behind the cover 30. As shown in FIG. 4, the protector 40 overlaps the cover 30 as seen in the vehicle front view. As shown in FIG. 5, the protector 40 is disposed above the first guide 34. The protector 40 is disposed between the first guide 34 and the second guide in the vertical direction. The protector 40 is disposed laterally outward of the third guide 36.

As shown in FIG. 6, the protector 40 includes a first conical portion 46, a second conical portion 47, and a concave groove 48. The first conical portion 46 has an upwardly tapering shape. The brake hose 28 extends upward from the first conical portion 46. The second conical portion 47 has a downwardly tapering shape. The brake hose 28 extends downward from the second conical portion 47. The concave groove 48 is disposed between the first conical portion 46 and the second conical portion 47. The concave groove 48 extends in the circumferential direction on the surface of the protector 40.

As shown in FIG. 7, the protector 40 includes a hole 49. The hole 49 extends through the protector 40 in the axial direction of the protector 40. A portion of the shrink tube 44 is disposed in the hole 49. The hole 49 includes a first hole 51 and a second hole 52. The second hole 52 has a larger inner diameter than the first hole 51. A portion of the first hose 41 that is not covered with the second hose 42 is disposed in the first hole 51. The second hose 42 is disposed in the second hole 52. A protrusion 53 is provided on the inner surface of the hole 49. The protrusion 53 extends in the circumferential direction of the hole 49. The hole 49 is provided on the inner surface of the first hole 51. The protrusion 53 engages the shrink tube 44.

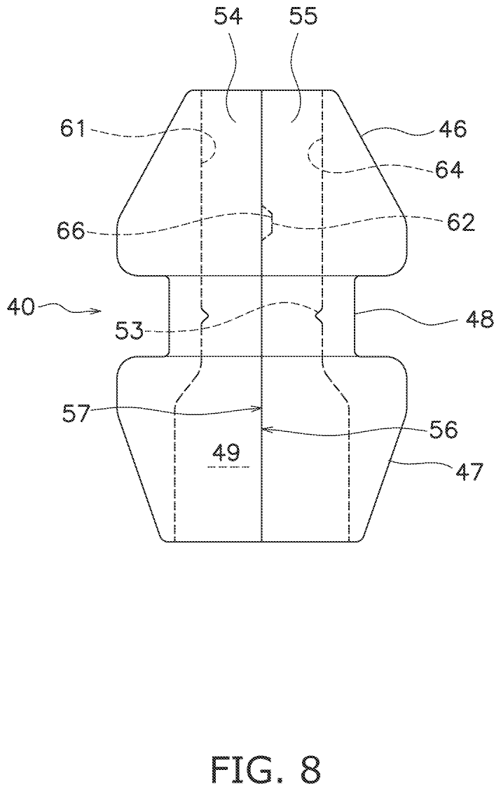

FIG. 8 is a side view of the protector 40. As shown in FIG. 8, the protector includes a first divided body 54 and a second divided body 55. The protector 40 is divided into the first divided body 54 and the second divided body 55 along a plane extending in the axial direction of the protector 40. The first divided body 54 covers the shrink tube 44 from one side. The second divided body 55 covers the shrink tube 44 from the other side.

The first divided body 54 includes a first mating surface 56. The second divided body 55 includes a second mating surface 57. By fixing the first divided body 54 and the second divided body 55 to each other, the second mating surface 57 and the first mating surface 56 are disposed to meet with each other. The first divided body 54 and the second divided body 55 are fixed to each other by a tie band 58 shown in FIG. 6. The tie band 58 is disposed in the concave groove 48.

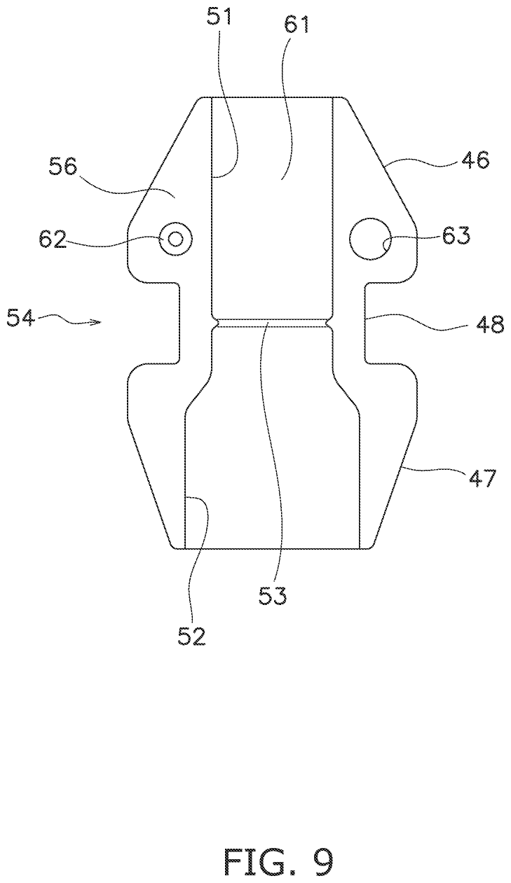

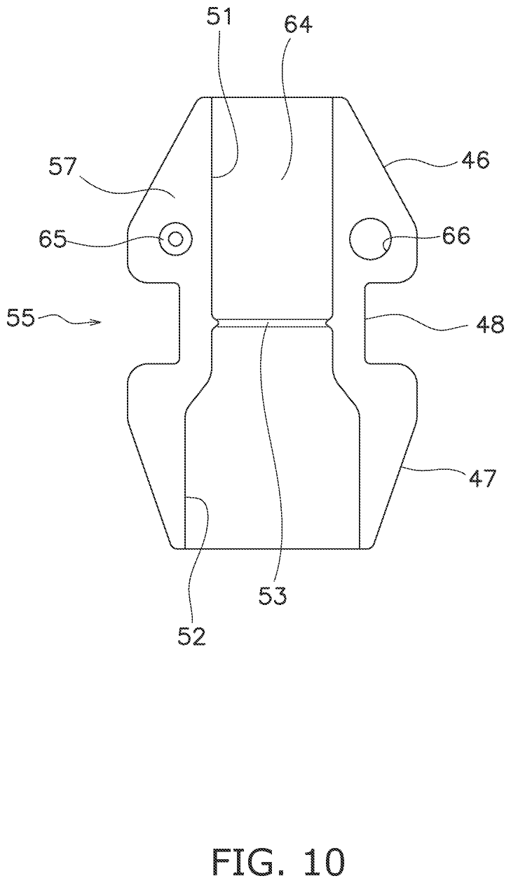

FIG. 9 is a diagram showing the first divided body 54. As shown in FIG. 9, the first mating surface 56 includes a first groove 61, a first protrusion 62, and a first recess 63. FIG. 10 is a diagram showing the second divided body 55. As shown in FIG. 10, the second mating surface 57 includes a second groove 64, a second protrusion 65, and a second recess 66. The first groove 61 and the second groove 64 each have a semi-cylindrical concave shape. The hole 49 of the protector 40 described above is configured by the first groove 61 and the second groove 64.

By fixing the first divided body 54 and the second divided body 55 to each other, the first protrusion 62 is disposed in the second recess 66. By fixing the first divided body 54 and the second divided body 55 to each other, the second protrusion 65 is disposed in the first recess 63. This prevents the first divided body 54 and the second divided body 55 from being displaced from each other.

In the straddled vehicle 1 according to the present embodiment described above, the shrink tube 44 connects the first hose 41 and the second hose 42 to each other. The shrink tube 44 is made of soft rubber, for example, and shrinks when heat is applied. Thereby, the first hose 41 and the second hose 42 of the brake hose 28 are connected to each other in a waterproof manner. Also, the shrink tube 44 is protected by the protector 40. Thereby, when the brake hose 28 moves due to the expansion and contraction of the front fork 15, the shrink tube 44 is prevented from rubbing against the cover 30 and being damaged.

Although one embodiment of the present invention has been described above, the present invention is not limited to the above-described embodiment, and various modifications are possible without departing from the gist of the invention.

The straddled vehicle 1 is not limited to the off-road type, and may be other types of vehicles such as a street type or a moped. The cover 30 is not limited to the number plate, and may be another cover such as a headlight cowl. The shape of the cover is not limited to that of the above embodiment, and may be changed. For example, the positions of the first through third guides 34 to 36 may be changed. The first through third guides 34 to 36 may be omitted.

The shape of the protector 40 is not limited to that of the above embodiment, and may be changed. For example, the protector 40 is not limited to a tapered shape, and may have a cylindrical or prismatic shape. The method of fixing the first divided body 54 and the second divided body 55 is not limited to the tie band 58. The first divided body 54 and the second divided body 55 may be fixed together by other methods such as snap-fitting or gluing.

### REFERENCE SIGNS LIST

4: Front wheel, 15: Front fork, 16: Upper bracket, 20: Front brake, 28: Brake hose, 30: Cover, 34: First guide, 40: Protector, 41: First hose, 42: Second hose, 44: Shrink tube, 48: Concave groove, 49: Hole, 53: Protrusion, 54: First divided body, 55: Second divided body, 58: Tie band

1. A straddled vehicle comprising:
a front wheel;
a front fork that rotatably supports the front wheel;
a cover disposed in front of the front fork;
a brake attached to the front wheel;
a brake hose connected to the brake and extending upward behind the cover; and
a protector attached to the brake hose, wherein
the brake hose includes
a first hose,
a second hose provided separately from the first hose, and
a shrink tube disposed behind the cover and connecting the first hose and the second hose, and
the protector is disposed behind the cover and covers the shrink tube.

2. The straddled vehicle according to claim 1, wherein
the protector includes
a first divided body that covers the shrink tube from a first side thereof, and
a second divided body that covers the shrink tube from a second side thereof and is attached to the first divided body.

3. The straddled vehicle according to claim 2, further comprising:
a tie band that fixes the first divided body and the second divided body to each other.

4. The straddled vehicle according to claim 3, wherein
the protector includes a concave groove extending in a circumferential direction of the protector on surfaces of the first divided body and the second divided body, and
the tie band is disposed in the concave groove.

5. The straddled vehicle according to claim 1, wherein
the protector includes
a hole for the shrink tube to be disposed therein, and
a protrusion disposed on an inner surface of the hole, for engaging with the shrink tube.

6. The straddled vehicle according to claim 1, wherein
the second hose is made of a harder material than the first hose.

7. The straddled vehicle according to claim 6, wherein
the cover includes a guide that guides the second hose.

8. The straddled vehicle according to claim 1, further comprising:
an upper bracket attached to the front fork, wherein
the cover is attached to the upper bracket.

9. The straddled vehicle according to claim 1, wherein
the cover is a number plate.

10. The straddled vehicle according to claim 1, wherein
the protector has a tapered shape.
